(19) United States
(12) Patent Application Publication
(10) Pub. No.: US 2011/0059206 A1
(43) Pub. Date: Mar. 10, 2011

(54) LOW-VISCOSITY FIBRE COMPOSITIONS

(75) Inventors: Johannes Wilhelmus Leonardus Boumans, Maarn (NL); Albert Jan Jacob Woortman, Veendam (NL)

(73) Assignee: Nederlandse Organisatie voor Toegepast- Natuurwetenschappelijk Onderzoek TNO

(21) Appl. No.: 12/920,822

(22) PCT Filed: Mar. 3, 2009
(86) PCT No.: PCT/NL2009/050094

§ 371 Date: Nov. 17, 2010

(30) Foreign Application Priority Data
Mar. 3, 2008 (EP) 08003929.0

(51) Int. Cl. A23L 1/308; A23L 2/52; A23L 1/302; A23C 9/158

(52) U.S. Cl. 426/72; 426/590; 426/580

(57) ABSTRACT

The invention pertains to the use of an α-1,3/α-1,6-glucan having a molecular weight of at least 10 kDa as a low-viscosity dietary fibre, and to liquid food compositions containing at least one of carbohydrates, fats and proteins and further containing such a glucan at a level of at least 1 wt. %.

The invention relates to liquid compositions containing dietary fibres and to the use of certain microbial polysaccharides as low-viscosity dietary fibres.

### BACKGROUND

Addition of fibre to food products is of increasing commercial interest, as Western consumers tend to consume not enough fibre. Fibres and pre-biotics contribute to a more balanced diet and should be easily ingested. Dietary fibres are available from various sources, such as plants, algae, bacteria and other organisms.

Many fibres, however, contribute strongly to the viscosity of the food product, thereby limiting the options for adding fibre to liquid food products, such as dairy drinks and beverages. An alternative is to use oligosaccharides, but these are less broadly available and moreover, may have insufficient fibre properties such as contributing to a desirable stool. A fibre that would combine a high molecular weight to low viscosity is therefore advantageous.

### DESCRIPTION OF THE INVENTION

It has now been found that high molecular weight glucans derived from food-grade lactic acid bacteria, especially Lactobacillus, in particular L. reuteri, can be used in liquid foods without substantially raising the viscosity of the product. This allows relatively high levels of fibres to be incorporated while maintaining complete liquid nature.

Thus, the invention pertains to the use of an α-1,3/α-1,6-glucan having a molecular weight of at least 10 kDa as a low-viscosity dietary fibre. Furthermore, the invention pertains to a liquid food product containing at least one of carbohydrates, fats and proteins, and further containing a dietary fibre which comprises a glucan having a molecular weight of at least 10 kDa, and having a viscosity, measured at a concentration of 3 wt. % in water at 20° C., which is less than 10 times the viscosity of water.

The concentration of the fibre (glucan) is at least 0.5 wt. %, preferably at least 1 wt. %, more preferably at least 2 wt. %, and most preferably at least 3 wt. %, up to e.g. 15 wt. %, preferably up to 10 wt. %, most preferably up to 7.5 wt. %.

The glucan to be used in the present invention is especially a water-soluble glucan. It is preferably a glucan having an average molecular weight of 10-100 MDa. The preferred has an α-1,3/α-1,6 glucan structure. In particular it comprises 17-40% α(1,3)-linked anhydroglucose units (AGU), 35-65% of α(1,6)-linked AGU, 5-20% of α(1,3,6)-linked AGU and 5-35% of terminal AGU. More in particular, it has 20-35% α(1,3)-linked AGU, 42-60% of α(1,6)-linked AGU, 8-18% of α(1,3,6)-linked AGU and 8-24% of terminal AGU. It can be produced by Lactobacilli, especially L. reuteri. A strain capable of producing such glucan effectively is L. reuteri strain 180, which was deposited as LMG P-18389 at the BCCM/LMG Culture Collection at Gent, Belgium. The strains and the glucans are described in WO 03/008618, see also Kralj et al. Microbiology (2004), 150, 3681-3690 The average molecular weight of the Lb 180 glucan was determined to be 3.6×10⁷ Da and the Rg was 45 nm.

The glucan as produced by the Lactobacillus strain may be used as such, but it may also be modified prior to use, provided that such modification does not substantially increase its viscosity. An advantageous modification is controlled hydrolysis, either by chemical (acid) or by enzymatic means. Hydrolysis should result in a minimum residual average molecular weight of 10,000 Da, preferably at least 50,000, most preferably at least 250,000 Da. Mild oxidation, e.g. using TEMPO-mediated 6 oxidation, is another modification that can be used. However, it is preferred to use the glucan without chemical modification, and preferably without substantial hydrolysis, i.e. with a molecular weight of at least 1 MDa, up to 100 MDa

The viscosity of the fibre is preferably less than 5 times, more preferably less than 3 times, most preferably less than 2 times the viscosity of water. The (dynamic) viscosity can be measured by conventional means, using art-known viscometers or rheometers, such as according to the Brookfield or other. The viscosity is measured with respect to water at a temperature of 20° C. and at a density of 3 wt. %.

The food product according to the invention preferably contains energy, i.e. between 10 and 120 kcal per 100 g. The lower ranges (e.g. between 15 and 60 kcal per 100 g) are useful for drinks and beverages, the higher ranges (up from 60 kcal/100 g) can apply to liquid energy compositions, also suitable as meal substitutes, e.g. for clinical use.

The food product preferably contains carbohydrates. The carbohydrate content can be e.g. between 2.5 and 20 wt. % preferably between 5 and 15 wt. % of carbohydrates. These carbohydrates are to be distinguished from the fibres, and are generally digestible carbohydrates. They may comprise sucrose, maltose, lactose, glucose, fructose and the like. In a dairy drink, the carbohydrates preferably comprise lactose (e.g. 1-6 wt. %) and optionally one or more of sucrose, glucose, fructose and galactose (in total. e.g. 0.1-5 wt. %). In fruit juices or beverages, the carbohydrates preferably comprise between 5 and 15 wt. % of one or more of sucrose, fructose and glucose.

Other digestible carbohydrates, such as maltodextrins may also be present, however preferably at low levels, e.g. less than 3 wt. % only. In addition to the low-viscosity, high-molecular weight glucan, the food product may contain other fibres, but preferably less than the level of the glucan. Such other fibres, if any, should have a low viscosity too. A suitable type of additional fibres include oligosaccharides, such as galacto-, manno-, or fructo-oligosaccharides, having a degree of polymerisation of 3-30, and having a concentration, if any, between 0 and 3 wt., especially between 0.01 and 1.5 wt. %. Other suitable types of fibres are those naturally present in fruit, such as cellulose, β-glucans and pectins.

The food product may or may not contain proteins. If it does, the preferred concentration is between 0.1 and 5 wt. % of proteins. Suitable proteins include milk proteins (caseins, whey proteins or both), especially in dairy drinks , preferably in a concentration between 1 and 5 wt. %. Soy proteins are other useful proteins. The proteins may be used as such or as partial hydrolysates.

The food product may also contain fats. The presence of fats may be useful in liquid energy compositions, e.g. at al level of between 1 and 5 g per 100 g. For other drinks, the fat content is preferably low, e.g. between 0.05 and 1 wt. %. Preferably, at least half of the fats is provided by polyunsaturated fatty acids such as linoleic, α-linolenic acid and higher homologues. Low-fat or fat-free compositions are also contemplated.

The food product may contain vitamins at common levels. Suitable vitamins include vitamin C, preferably between 1 and 100, more preferably between 5 and 50 mg vitamin C, vitamin A (e.g. between 0.1 and 2.5 μg), vitamin E (e.g. between 0.02 and 1 mg) and folic acid (e.g. between 5 and 50 μg), all per 100 g liquid product. Carotenoids may be present e.g. at a level of between 5 and 75 μg per 100 g.

Suitable minerals (per 100 g liquid product) include potassium (e.g. 20-300 mg), sodium (2-75 mg), calcium (5-200 mg), magnesium (2-50 mg), phosphorus (2-100 mg), iron (0.05-2.5 mg), and trace elements

In the liquid food product of the invention, containing at least one of carbohydrates, fats and proteins, the dietary fibre may be present in an amount of at least 5 wt. % with respect to the dry weight of the sum of the carbohydrates, fats and proteins, up to e.g. 25 wt. %.

The food product is preferably a liquid food product. However, the invention also covers dry products which can be reconstituted to drinks or other liquid products by suitable addition of water. The dry substance level of the liquid products is preferably between 2 and 20 wt. %, more preferably between 5 and 15 wt. %. The composition of dry products can be derived from the above figures by assuming a dry substance level of 10 g/100 g. The concentration of the low-viscous glucan fibre of the invention in a dry composition can be related to the (other) carbohydrate content, in particular as between 5 and 15 wt. % of carbohydrates.

The food product may also contain probiotics, i.e. valuable micro-organisms, which contribute to an optimum intestinal function. These comprise lactic acid bacteria, especially Lactobacilli, Bifidobacteria, Streptococci, Pediococci etc. including strains of Lactobacillus reuteri. Also, fermenting microorganisms may be present such as Lactobacillus acidophilus, Lb. lactis, Lb. delbrueckii/bulgaricus, Streptococcus thermophilus, Propionibacterium ssp. etc.

The liquid product may contain further ingredients, such as colorants, preservatives, stabilisers, gas (although the latter is not preferred), etc.

Examples of food product of the invention include dairy drinks, fruit juices, e.g. apple, grapefruit, orange, grape, blackberries, and many others, and beverages such a s sport and health drinks.

Test results: Viscosity of Lb 180 Glucan

Of each of the materials listed below, a 3% solution was prepared in distilled water, followed by moderate mixing overnight. Viscosity was measured at 20° C. and a shear rate of 50 [l/s].

| | Viscosity |
|---|---|
| Product | [mPa · s] |
| Glucan GTF 180 (strain Lb 180) (invention) | 1.35 |
| Dextran T2000 (MW ~2.5 MDa) | 6.53 |
| κ-Carrageenan | 8.6 |
| Pectin high-methoxyl | 67.8 |
| Carboxymethylcellulose (m-v) | 1470 |
| Guar | 6330 |
| water | 1.0 |

The results show that Lb 180 glucan contributes very little to the viscosity, the viscosity of a 3% solution being only slightly higher than that of water. In contrast, viscosities of solutions of commercially available dextran and that of other conventional food fibres are much higher.

### EXAMPLE

A fibre-enforced fruit drink was prepared by mixing the following ingredients per 100 ml final product, pasteurizing and packaging in bottles of 250 ml.

| | | |
|---|---|---|
| Orange concentrate | 20 | g |
| fructose | 2 | g |
| maltodextrins, DE 10 | 8 | g |
| whey protein hydrolysate (30% protein) | 5 | g |
| vitamin C | 20 | mg |
| citric acid | 50 | mg |
| Lb180 glucan MW 3.6 MDa | 5 | g |
| water up to | 100 | ml |

Energy: 45 kcal/100 ml

1. A liquid food product comprising:
(a) at least one of carbohydrates, fats and proteins, and
(b) at least 1 wt.% of a dietary fibre comprising a glucan, and having:
a molecular weight of at least 10 kDa, and
(ii) a viscosity, measured at a concentration of 3 wt. % in water at 20° C., less than 3 times the viscosity of water.

2. The food product according to claim 1, comprising at least 2 wt. % of the dietary fibre.

3. The food product according to claim 1, wherein the fibre has a molecular weight of 1-100 MDa.

4. The food product according to claim 1, wherein the glucan is an α-1,3/α-1,6 glucan.

5. The food product according to claim 1, wherein the viscosity is less than 5 times the viscosity of water.

6. The food product according to claim 1, comprising between 5 and 15 wt. % of carbohydrates.

7. The food product according to claim 1, comprising between 0.1 and 5 wt. % of proteins.

8. The food product according to claim 1, comprising between 1 and 5 wt. % of proteins.

9. The food product according to claim 1, having between 15 and 60 kcal per 100 g of food product.

10. The food product according to claim 1, which contains between 0.5 and 100 mg vitamin C per 100 g of the product.

11. A liquid food product comprising:
(a) at least one of carbohydrates, fats and proteins, and
(b) a dietary fibre in an amount of at least 5 wt. % with respect to the dry weight of the sum of the carbohydrates, fats and proteins,
wherein the dietary fibre is a glucan having a molecular weight of at least 10 kDa, and having a viscosity, measured at a concentration of 3 wt. % in water at 20° C., which is less than 5 times the viscosity of water.

12. A liquid food product comprising an α-1,3/α-1,6-glucan having a molecular weight of at least 10 kDa.

13. The food product according to claim 1, which contains the fibre in a concentration of between 3 and 10 wt. %.

14. The food product according to claim 1, wherein the fibre has a viscosity, which is less than 3 times the viscosity of water.

15. The food product according to claim 1, which contains between 5 and 50 mg vitamin C per 100 g food product.

16. The food product according to claim 8, wherein the protein is milk protein.
